(19) United States
(12) Patent Application Publication
(10) Pub. No.: US 2016/0289364 A1
(43) Pub. Date: Oct. 6, 2016

(54) GRAFTED POLYMER COMPOSITIONS

(71) Applicant: SACO AEI POLYMERS, INC., Sheboygan, WI (US)

(72) Inventors: Christopher L. Ross, Sheboygan, WI (US); Jeffrey Jacob Cernohous, Hudson, WI (US); Neil R. Granlund, Columbia Heights, MN (US); David Geraint Roberts, Sheboygan Falls, WI (US)

(73) Assignee: SACO AEI Polymers, Inc., Sheboygan, WI (US)

(21) Appl. No.: 15/036,972

(22) PCT Filed: Oct. 22, 2014
(86) PCT No.: PCT/US14/61792

§ 371 Date: May 16, 2016

Related U.S. Application Data
(60) Provisional application No. 61/907,541, filed on Nov. 22, 2013.

(51) Int. Cl. C08F 255/02; C08L 51/08; C08L 23/06; C08L 51/06; C08F 289/00; C08L 23/12

(52) U.S. Cl. CPC C08F 255/02; C08F 289/00; C08L 23/12; C08L 23/06; C08L 51/06; C08L 51/08; C08L 2205/16; C08L 2201/02

(57) ABSTRACT

A grafted polymer derived from the free radical reaction of a polymer, a reactive low molecular weight polymer and optionally an ethylenically unsaturated reactive monomer is provided. The grafted polymer compositions may be produced using melt processing techniques, such as reactive extrusion. Composite compositions including the grafted polymer product, a host polymer, and a cellulosic filler are also provided.

### BACKGROUND

Polymeric materials are used throughout the world in innumerable applications and markets. Polymer additives are commonly utilized to impart desired performance or properties to these polymeric materials, depending on the application requirements. For example, flame retardant additives are often included in a polymeric material in order to improve flammability. There exist polymer additives that have been designed to impart any number of attributes, including, for example, ultraviolet light stability, oxidative stability, lubrication, improved processibility, color/aesthetics, modified surface energy, compatibility, improved mechanical properties, and flammability. Wood Plastic Composites (WPC's) are widely used today in the building and construction market. The processing of WPC's often requires the application of polymer additives to enhance processing and the physical properties of the finished WPC articles. Conventional additives are not fully capable of achieving desired results and often demonstrate certain deficiencies.

### SUMMARY

This application is directed to a grafted polymeric composition that possesses unique utility when serving as a polymer additive. Specifically, the grafted polymer, when added to polymeric formulations such as WPC's, may impart unique and unexpected properties, such as modified surface energy, improved flammability characteristics and/or enhanced lubricity. In one embodiment, the grafted polymer compositions may impart superior lubrication performance when compared to conventional lubricants used in melt processing applications.

This application provides a grafted polymeric composition derived from a free radical reaction between a polymer and a reactive low molecular weight polymer. In one embodiment, the grafted polymer composition further comprises reactive moiety that is derived from a free radical reaction of a polymer with an ethylenically unsaturated reactive monomer and a hydrophobic or hydrophilic low molecular weight polymer.

The grafted polymer may be derived from the free radical reaction of a polymer, a reactive low molecular weight polymer and optionally an ethylenically unsaturated reactive monomer. The reactive low molecular weight polymer is typically a polymer with a number average molecular weight of less than 20,000 g/mol that is capable of undergoing free radical reactions with the polymer matrix to form a grafted polymer. In some embodiments, the reactive low molecular weight polymer may be a hydrophilic polymer or hydrophobic polymer. In other embodiments, an ethylenically unsaturated reactive monomer may be melt processed with the other constituents. The ethylenically unsaturated reactive monomer can impart additional reactivity to the resulting grafted polymer.

In certain embodiments, the grafted polymer is generally formed through reactive extrusion. The reactive extrusion process is well suited to form the grafted polymer of this disclosure. The efficiency of the process can be at least partially measured by the amount or level of free low molecular weight polymers in the finished grafted polymer. Some embodiments of the grafted polymer compositions are typically characterized by less than 1% by weight free low molecular weight polymers.

In one embodiment, WPCs produced using a polymeric matrix, cellulosic fillers and the grafted polymer compositions of this disclosure have improved moisture resistance and dimensional stability. The grafted polymer compositions may also show improved flammability and/or modified surface energy when added to polymeric compositions.

Certain embodiments provide a composition comprising a reaction product produced by grafting one or more matrix polymers with a reactive low molecular weight polymer in the presence of a free radical initiator and, optionally, an ethylenically unsaturated reactive monomer. The reactive low molecular weight polymer may be hydrophobic polymer or a hydrophilic polymer. The reactive low molecular weight polymer typically has a number average molecular weight of no more than about 20,000 g/mole and, more commonly, no more than about 10,000 g/mole. The composition typically includes a host polymer in addition to the reaction product. The host polymer may be the same or different from the matrix polymer used to produce the reaction product. Such compositions may include a filler (e.g., a mineral and/or cellulosic filler) and/or a lubricant.

The following terms used in this application are defined as follows:

“Grafted Polymer” means a polymeric composition derived from a free radical reaction of a polymer and a hydrophilic or hydrophobic low molecular weight polymer and optionally an ethylenically unsaturated reactive monomer.

“Reactive Low Molecular Weight Polymer” means a polymer with a number average molecular weight of less than 20,000 g/mol that is capable of undergoing free radical reactions with the polymer matrix to form a grafted polymer.

“Composite” means a mixture of a polymeric material and an additive and/or filler.

“Melt Processable Composition” means a formulation that is melt processed, typically at elevated temperatures, by means of a conventional polymer processing technique such as extrusion or injection molding as an example.

“Melt Processing Techniques” means extrusion, injection molding, blow molding, rotomolding, or batch mixing.

“Hydrophilic” means polar (i.e., water miscible or dispersible).

“Hydrophobic” means nonpolar (i.e., oil miscible or dispersible).

“Cellulosic Material” means natural or man-made materials derived from cellulose. Cellulosic materials include for example: wood flour, wood fibers, sawdust, wood shavings, agricultural fibers, newsprint, paper, flax, hemp, grain hulls, kenaf, jute, sisal, nut shells or combinations thereof.

“Ethylenically unsaturated monomers” means those monomers having carbon-carbon double bonds that possess the ability to “saturate” the molecule by addition of H₂.

The above summary is not intended to describe each disclosed embodiment or every implementation. The detailed description that follows provides illustrative embodiments that more particularly exemplify the compositions and methods described herein.

### DETAILED DESCRIPTION

Grafted polymer compositions of this disclosure may be formed by free radically grafting a polymer with a reactive low molecular weight polymer. In one embodiment, the grafted polymer composition further includes a reactive moiety by including an ethylenically unsaturated reactive monomer in the composition. The grafted polymer compositions may be produced using melt processing techniques, such as, for example, reactive extrusion.

The grafted polymer compositions of this application have been found to have utility as polymeric additives for polymer compositions. In one embodiment, the grafted polymer compositions provide superior lubrication performance and enable the processing of highly filled polymeric compositions, including wood plastic composites (WPC's). In another embodiment, the grafted polymer compositions may improve the flammability characteristics of flame retardant polymeric compositions. In another embodiment, the grafted polymer compositions may impart modified surface energy to a polymeric film or substrate leading to reduced coefficient of friction.

A polymeric matrix can function as the host polymer and may be used as a component of the melt processable composition. The polymer matrix can comprise one or more polymers that function as the primary polymeric structure upon which the low molecular weight polymer is grafted. A wide variety of polymers conventionally recognized in the art as suitable for melt processing are useful as the polymeric matrix. The polymeric matrix substantially includes polymers that are capable of undergoing free radical grafting reactions. They include both hydrocarbon and non-hydrocarbon polymers. Non-limiting examples of useful polymeric matrices include, but are not limited to: polyamides, polyimides, polyurethanes, polyolefins, polystyrenes, polyesters, polycarbonates, polyketones, polyureas, polyvinyl resins, polyacrylates and polymethylacrylates. In certain embodiments, a polyolefin polymer or copolymer is well suited to function as the polymeric matrix, e.g., a polyolefin polymer or copolymer.

In another embodiment, polymeric matrices include high density polyethylene (HDPE), low density polyethylene (LDPE), linear low density polyethylene (LLDPE), polypropylene (PP)), polyolefin copolymers (e.g., ethylene-butene, ethylene-octene, ethylene vinyl alcohol), polystyrene, polystyrene copolymers (e.g., high impact polystyrene, acrylonitrile butadiene styrene copolymer), polyacrylates, polymethacrylates, polyesters, polylactic acid, polyvinylchloride (PVC), fluoropolymers, liquid crystal polymers, polyamides, polyether imides, polyphenylene sulfides, polysulfones, polyacetals, polycarbonates, polyphenylene oxides, polyurethanes, thermoplastic elastomers, epoxies, alkyds, melamines, phenolics, ureas, vinyl esters or combinations thereof. Those of ordinary skill in the art with knowledge of this disclosure are capable of selecting a polymer or polymers that are well suited for the desired end use application.

Polymeric matrices that are derived from recycled plastics are also applicable as they are often lower cost. Non-limiting examples of recycled polymer matrices include those derived from polypropylene, polypropylene copolymers, polyethylene and polyethylene copolymers.

The polymeric matrix is included in the melt processable compositions in amounts of typically greater than about 30% by weight. Those skilled in the art recognize that the amount of polymeric matrix will vary depending upon, for example, the type of polymer, the type of reactive low molecular weight polymer, the selected free radical initiator, the type of reactive ethylenically unsaturated monomer, processing conditions and the desired end product.

The reactive low molecular weight polymer must be capable of undergoing a free radical grafting reaction with the polymer matrix and a free radical initiator. In one embodiment, the low molecular weight polymer has a number average molecular weight less than 20,000 g/mol. In other embodiments, the low molecular weight polymer has a number average molecular weight of less than 10,000 g/mol. The low molecular weight polymer may be hydrophobic or hydrophilic in nature. Non-limiting examples of reactive low molecular weight polymers include siloxane polymers and oils, siloxane copolymers, hydrocarbon oils and waxes and polyalkylene oxides and glycols.

The melt processable composition may optionally include a functional ethylenically unsaturated monomer to impart additional reactivity to the resulting grafted polymer. Non-limiting examples of ethylenically unsaturated monomers include α,o-functionalized olefins (e.g., amine, hydroxyl, carboxylic acid, anhydride terminal), α,β-unsaturated aldehydes, α,β-unsaturated ketones, α,β-unsaturated esters (e.g., acrylates, methacrylates, maleates) and vinyl silanes. In one embodiment, maleic anhydride is utilized as the functional ethylenically unsaturated monomer.

In one embodiment, the grafted polymers are produced by melt processing the reactive low molecular weight hydrophilic or hydrophobic polymer in the presence of a free radical initiator. Free radical initiators include organic peroxides and diazocompounds. Non-limiting examples of specific free radical initiators include: benzoyl peroxide, dicumyl peroxide, di-tert-butyl peroxide and azoisobutrylnitrile.

The amount of components in the melt processable, graft copolymer composition may vary depending upon the intended end use application. The base polymer may comprise from about 40 to about 99 percent by weight of the final composition. The reactive low molecular weight polymer may be included in at a level of up to 50 percent by weight. The optional ethylenically unsaturated reactive monomer may be included in the melt processable composition of up to 10 percent by weight.

In another embodiment, the melt processable composition may contain other additives. Non-limiting examples of conventional additives include antioxidants, light stabilizers, fibers, blowing agents, foaming additives, antiblocking agents, heat stabilizers, impact modifiers, biocides, compatibilizers, plasticizers, tackifiers, colorants, processing aids, lubricants, coupling agents, and pigments. The additives may be incorporated into the melt processable composition in the form of powders, pellets, granules, or in any other extrudable form. The amount and type of conventional additives in the melt processable composition may vary depending upon the polymeric matrix and the desired physical properties of the finished composition. Those skilled in the art of melt processing are capable of selecting appropriate amounts and types of additives to match with a specific polymeric matrix in order to achieve desired physical properties of the finished material.

In another aspect of the disclosure, the grafted polymers described have utility themselves as additives to improve the processing of polymers and polymer composites. In one embodiment, the grafted polymers have utility as lubricants in polymers filled with cellulosic materials, such as natural fiber composites or wood plastic composites (WPC's). Such composites have found extensive application and use as building materials. However, it is known that wood plastic composites (WPC's) often contain 40-70% wood flour or fiber in the formulation. As a result, the melt viscosity of WPC systems is often very high, and the processibility is extremely poor. In WPC decking extrusion, the extrudate can suffer from a phenomenon referred to as edge tear. This arises when the material is processed at too high of a rate, causing a regular and severe tearing of the surface of the extruded composite. The additives disclosed here effectively reduce torque, reduce melt pressure and improve melt defects in polymeric matrices filled with cellulosic materials.

Cellulosic materials are commonly utilized in melt processable compositions to impart specific physical characteristics or to reduce the cost of the finished composition. Cellulosic materials generally include natural or wood based materials having various aspect ratios, chemical compositions, densities, and physical characteristics. Non-limiting examples of cellulosic materials include wood flour, wood fibers, sawdust, wood shavings, newsprint, paper, flax, hemp, rice hulls, kenaf, jute, sisal, peanut shells. Combinations of cellulosic materials, or cellulosic materials may also be used in the melt processable composition.

In another embodiment, the grafted polymer is combined with a lubricant to improve the processibility of a highly filled polymer. The lubricant may be hydrophobic, hydrophilic or amphiphilic in nature. Non-limiting examples of lubricants include hydrocarbon waxes, metal stearates, stearates, alkyl amides, polyalkylene oxides, silanes, siloxanes, and glycols.

In yet another embodiment, a mineral filler may be used with a host polymer and the grafted polymer of this disclosure. Non-limiting examples of mineral fillers include silicates, aluminoslicates, metal oxides, talc, mica, clay, alumina, carbon fiber and carbon black. The additives disclosed here effectively reduce torque, reduce melt pressure and improve melt defects in polymeric matrices containing fillers.

Flame retardant materials may also be added either in the formation of the grafted polymer or with the finished grafted polymer in its end use application with another host polymer. The flame retardant can be either a halogenated or non-halogenated material. Non-limiting examples of flame retardants and flame retardant synergists include organohalogen compounds (ogranochlorines, organobromines and halogenated polymers) and synergists (antimony trioxide), Organophosporous compounds (organophosphates, organophosphonates, organophosphinates), inorganic minerals (metal hydroxides, metal hydrates, red phosphorous, borates). Non-limiting examples of specific flame retardants include aluminum hydroxide, magnesium hydroxide, red phosphorous, decabromodiphenylether, decabromodiphenylethane, tetrabromophthalic anhydride, tetrabromobisphenol A, hexabromocyclododecane, antimony trioxide, brominated and chlorinated polymers and oligomers, triphenyl phosphate, dimethyl methylphosphonate, diphenylphosphate, tricresyl phosphate, ammonium polyphosphate, melamine phosphate, diethyl phosphinate. The grafted polymers can improve the processing of the flame retardant formulation, impart improved flammability characteristics and reduce the coefficient of friction of the resulting extruded flame retardant articles.

The grafted polymers can be added to a polymeric matrix to impart novel surface properties of the resultant polymeric article. In one embodiment, adding a hydrophobic grafted polymer to a polymer matrix results in reducing the surface energy of the polymeric article. In another embodiment, adding a hydrophilic grafted polymer to the polymer matrix resulting in increasing the surface energy of the resulting polymeric article. In another embodiment, the addition of a both hydrophobic and hydrophilic grafted polymers to a polymeric article can provide an amphiphilic surface, where the article is receptive to both hydrophobic or hydrophilic materials. Modifying the surface energy of a polymeric article can impart a number of practical attributes including antigraffiti character, improved stain repellency, improved printability and paintability, and self cleaning characteristics.

The melt processable, grafted polymer composition can be prepared by any of a variety of ways. For example, the components can be combined together by any of the blending means usually employed in the plastics industry, such as with a compounding mill, a Banbury mixer, or a mixing extruder. The materials may be used in the form, for example, of a powder, a pellet, or a granular product. The mixing operation is most conveniently carried out at a temperature above the melting point or softening point of the polymer. The resulting melt-blended mixture can be either extruded directly into the form of the final product shape or pelletized or otherwise comminuted into a desired particulate size or size distribution and fed to an extruder, which typically will be a twin-screw extruder, that reactively melt-processes the blended mixture to form the final product shape. Alternatively, the composition may be molded into a desired form. The resulting composite exhibits superior performance results when the hyper-branched polymer is produced using this protocol.

Melt-processing typically is performed at a temperature from 80° to 300° C., although optimum operating temperatures are selected depending upon the melting point, melt viscosity, and thermal stability of the composition. Different types of melt processing equipment, such as extruders, may be used to process the melt processable compositions of this disclosure.

The grafted polymer compositions are suitable as additives for plastics. They impart improved strength, flammability, lubricity, processability, abrasion resistance, stain resistance, and modified surface energy. Such features are useful in producing polymeric compositions that have application for manufacturing articles in the construction, electronics, consumer goods and automotive industries. For example, articles incorporating the composition of the present disclosure may include: molded architectural products, forms, automotive parts, building components, household articles, or electronic hard goods.

The resulting articles produced by melt processing the inventive composition may exhibit superior properties, such as improved processability, moisture resistance, flammability and/or modified surface energy characteristics.

### ILLUSTRATIVE EMBODIMENTS

One embodiment of the present composition includes a reaction product produced by grafting one or more first polymers with a reactive low molecular weight polymer in the presence of a free radical initiator, where low molecular weight polymer includes siloxane polymer, siloxane oil, siloxane copolymer, hydrocarbon oil or a combination thereof. The compositions may also include a mineral and/or cellulosic filler and/or a lubricant. Suitable lubricants include hydrocarbon wax, metal stearate, alkyl amide, glycol and/or polyalkylene oxide. The first polymer may be selected from polyamides, polyimides, polyurethanes, polyolefins, polystyrenes, polyesters, polycarbonates, polyketones, polyureas, polyvinyl resins, polyacrylates, polymethylacrylates and combinations thereof. The composition may also include one or more other additives, such as antioxidants, light stabilizers, fibers, blowing agents, foaming additives, antiblocking agents, heat stabilizers, impact modifiers, biocides, compatibilizers, plasticizers, tackifiers, colorants, processing aids, coupling agents, and/or pigments.

Another embodiment of the present composition includes a reaction product produced by grafting one or more matrix polymers with a reactive low molecular weight polymer in the presence of a free radical initiator and an ethylenically unsaturated reactive monomer. The low molecular weight hydrophobic polymer typically has a number average molecular weight of no more than about 20,000 g/mole and may include siloxane polymer, siloxane oil, siloxane copolymer, hydrocarbon oil or a combination thereof. In some embodiments, the matrix polymers may include polyolefin, polyolefin copolymer, polyester or a combination thereof (e.g., polypropylene, polyethylene and/or polylactic acid). Such compositions may include siloxane oil as the low molecular weight hydrophobic polymer. The grafting reaction may optionally be carried out in the presence of a low molecular weight hydrophobic polymer, which comprises siloxane oil, and an ethylenically unsaturated reactive monomer, such as maleic anhydride or vinyl triethoxysilane. The compositions may also include a filler (e.g., cellulosic filler) and/or a lubricant, such as a metal stearate.

Another embodiment provides grafted polymeric composition comprising a reaction product produced by grafting polyolefin and/or polyolefin copolymer (e.g., polypropylene and/or polyethylene) with a first polymer in the presence of a free radical initiator and, optionally, an ethylenically unsaturated reactive monomer. The first polymer may include a siloxane polymer, siloxane oil, siloxane copolymer oil or a combination thereof. Typically, the first polymer comprises siloxane oil. The reaction product may be produced by grafting polypropylene and/or polyethylene with the first polymer in the presence of the free radical initiator and an ethylenically unsaturated reactive monomer, which includes maleic anhydride. For example, the reaction product may be produced by grafting polyethylene with a siloxane oil in the presence of the free radical initiator. In another example, the reaction product may be produced by grafting polyethylene with a siloxane oil in the presence of the free radical initiator and maleic anhydride. In yet another example, the reaction product may be produced by grafting polypropylene with a siloxane oil in the presence of the free radical initiator. In yet another example, the reaction product may be produced by grafting polypropylene with a siloxane oil in the presence of the free radical initiator and maleic anhydride. A composite composition may be produced by melt blending any of the grafted polymeric compositions described above with a cellulosic filler. Such composite compositions typically also include a host polymer, e.g., a polyolefin and/or polyolefin copolymer.

Another embodiment provides a composite composition which includes a host polymer, a grafted polymeric product (such as those described above) and a cellulosic filler. The grafted polymeric product is commonly produced by reacting polyolefin and/or polyolefin copolymer with a first polymer in the presence of a free radical initiator and, optionally, an ethylenically unsaturated reactive monomer (such as maleic anhydride or vinyl triethoxy silane). The first polymer is typically a siloxane polymer, siloxane oil, siloxane copolymer, or a combination thereof. Often, the first polymer includes a siloxane oil. The polyolefin and/or polyolefin copolymer may include polypropylene and/or polyethylene. The grafted polymeric product may be produced by reacting at least about 40 wt. % of the polyolefin and/or polyolefin copolymer with up to about 50 wt. % the reactive low molecular weight polymer in the presence of a free radical initiator and no more than about 10 wt. % of the optional ethylenically unsaturated reactive monomer. In such composite materials, the host polymer may be polypropylene and/or polyethylene and the cellulosic filler may include wood flour and/or wood fiber. For example, the grafted polymeric product may be produced by reacting at least about 40 wt. % polypropylene with at least about 10 wt. % siloxane oil and at least about 1 wt. % maleic anhydride in the presence of the free radical initiator. In another example, the grafted polymeric product may be produced by reacting at least about 40 wt. % polyethylene with at least about 10 wt. % siloxane oil and at least about 1 wt. % maleic anhydride in the presence of the free radical initiator.

### EXAMPLES

Materials used to generate the following examples include:

| Material | Description |
|---|---|
| PP | Exxon 5262, polypropylene, commercially available from |
| | Exxon Mobil Corporation (Baytown, TX) |
| PE | Sclair 31E, linear low density polyethylene, commercially |
| | available from Nova Chemical Corporation (Calgary, AB) |
| PLA | Ingeo 2003D, commercially available from Natureworks LLC |
| | (Minnetonka, MN) |
| Silicone | Wacker AK350 Silicone Fluid, commercially available from |
| | Wacker Chemie Corporation (Adrian, MI) |
| Initiator 1 | Dicumyl Peroxide, commercially available from Sigma |
| | Aldrich (Milwaukee, WI) |
| VTOES | Vinyl triethoxysilane, commercially available from |
| | Aldrich Chemical Corporation (Milwaukee, WI) |
| MA | Maleic Anhydride, commercially available from Aldrich |
| | Chemical Corporation (Milwaukee, WI) |

Grafted polymer compositions were prepared using the following protocol. Resin and optionally maleic anhydride (or vinyl triethoxysilane) were premixed in a plastic bag and gravimetrically fed into the extruder throat. Silicone and initiator were injected downstream into a 27 mm co-rotating twin screw extruder (36:1, L:D) fitted with a three strand die (commercially available from American Leistritz Extruder Corporation, Somerville, N.J.). All samples were processed at 100 rpm screw speed using the following temperature profile: Zone 1=130° C., Zone 2 =150° C. Zone 3-4=220° C., Zone 5-6=200° C., Zone 7=145° C., Zone 7=125° C., Die=125° C. The resulting strands were subsequently cooled in a water bath and pelletized into 0.64 cm pellets.

Table 1 provides the formulations for grafted polymer compositions examples 1-11 that were produced. Table 2 lists key characteristics of Comparative Examples CE1-CE2 and Examples 1-6.

TABLE 1
Formulations Comparative Examples CE1-CE3 and Examples 1-11

| Exam- | PE | PP | PLA | Silicone | VTOES | MA | Initiator |
|---|---|---|---|---|---|---|---|
| ple | (wt %) | (wt %) | (wt %) | (wt %) | (%) | (%) | (wt %) |
| CE1 | 100 | — | — | — | — | — | — |
| CE2 | — | 100 | — | — | — | — | — |
| CE3 | — | — | 100 | — | — | — | — |
| 1 | 89 | — | — | 10 | — | — | 1 |
| 2 | 79 | — | — | 20 | — | — | 1 |
| 3 | 69 | — | — | 30 | — | — | 1 |
| 4 | — | 89 | — | 10 | — | — | 1 |
| 5 | — | 79 | — | 20 | — | — | 1 |
| 6 | — | 69 | — | 30 | — | — | 1 |
| 7 | — | — | 89 | 10 | — | — | 1 |
| 8 | — | — | 79 | 20 | — | — | 1 |
| 9 | 78 | — | — | 20 | — | 1 | 1 |
| 10 | — | 78 | — | 20 | — | 1 | 1 |
| 11 | — | 78 | — | 20 | 1 | — | 1 |

TABLE 2
Properties of Comparative Examples CE1-CE3 and Examples 1-6

| | Specific Gravity | Limiting Oxygen Index |
|---|---|---|
| Example | (g/cc) | (%) |
| CE1 | 0.90 | 17 |
| CE2 | 0.94 | 17 |
| 1 | 0.91 | 19 |
| 2 | 0.91 | 17 |
| 3 | 0.91 | 18 |
| 4 | 0.93 | 21 |
| 5 | 0.93 | 17 |
| 6 | 0.93 | 17 |

From the above disclosure of the general principles in this disclosure and the preceding detailed description, those skilled in this art will readily comprehend the various modifications to which the present invention is susceptible.

1-45. (canceled)

46. A melt processable composition comprising a reaction product produced by melt processing a mixture comprising a free radical initiator, one or more first polymers, a reactive low molecular weight polymer and, optionally, an ethylenically unsaturated reactive monomer;
wherein the one or more first polymers comprises polyolefin, polyolefin copolymer and/or polyester; and the reactive low molecular weight polymer comprises siloxane polymer, siloxane oil, siloxane copolymer or combination thereof.

47. The melt processable composition of claim 46, wherein the ethylenically unsaturated reactive monomer is selected from α,o-functionalized olefins, α,β-unsaturated aldehydes, α,β-unsaturated ketones, α,β-unsaturated esters, and vinyl silanes.

48. The melt processable composition of claim 46, wherein the one or more first polymers comprises high density polyethylene (HDPE), low density polyethylene (LDPE), linear low density polyethylene (LLDPE), polypropylene (PP)), polyolefin copolymer or a combination thereof.

49. The melt processable composition of claim 46, wherein the one or more first polymers comprises polylactic acid (PLA).

50. The melt processable composition of claim 46, wherein the reactive low molecular weight polymer has a number average molecular weight of less than 20,000 g/mole.

51. The melt processable composition of claim 46, wherein the ethylenically unsaturated reactive monomer comprises maleic anhydride.

52. The melt processable composition of claim 46, wherein the ethylenically unsaturated reactive monomer comprises a vinyl silane.

53. The melt processable composition of claim 46, wherein the reactive low molecular weight polymer comprises siloxane oil; and the one or more first polymers comprises polyolefin, polyolefin copolymer or a combination thereof.

54. The melt processable composition of claim 53, wherein the mixture further comprises maleic anhydride.

55. The melt processable composition of claim 53, wherein the mixture further comprises vinyl silane.

56. The melt processable composition of claim 46, wherein the reactive low molecular weight polymer comprises the siloxane oil; and the one or more first polymers comprises polyester.

57. The melt processable composition of claim 46, wherein the reaction product is produced by melt processing a mixture comprising at least about 40 wt. % of the polyolefin and/or polyolefin copolymer with up to about 50 wt. % of the reactive low molecular weight polymer and no more than about 10 wt. % of the optional ethylenically unsaturated reactive monomer in the presence of the free radical initiator.

58. The melt processable composition of claim 57, wherein the reaction product is produced by melt processing a mixture comprising at least about 40 wt. % polypropylene or polyethylene with at least about 10 wt. % siloxane oil and at least about 1 wt. % maleic anhydride in the presence of the free radical initiator.

59. The melt processable composition of claim 57, wherein the reaction product is produced by melt processing a mixture comprising at least about 40 wt. % polyolefin with at least about 10 wt. % siloxane oil and at least about 1 wt. % vinyl silane in the presence of the free radical initiator.

60. A composite composition comprising a polymer matrix, cellulosic filler and the reaction product of claim 46.

61. The composite composition of claim 60, further comprising a lubricant.

62. The composite composition of claim 60, wherein cellulosic filler comprises wood flour, wood fibers, sawdust, wood shavings, newsprint, paper, flax, hemp, rice hulls, kenaf, jute, sisal, peanut shells or a combination thereof.

63. The composite composition of claim 60, wherein the reactive low molecular weight polymer comprises a siloxane oil; the polymer matrix comprises polyolefin, polyolefin copolymer, polyester or a combination thereof and the cellulosic filler comprises wood flour and/or wood fibers.

64. The composite composition of claim 60, wherein the composition comprises about 40-70% wood flour and/or wood fiber; and the polymer matrix comprises polypropylene or polyethylene.

65. A method of producing a melt processable composition comprising reactively melt processing a mixture comprising a free radical initiator, one or more first polymers, a reactive low molecular weight polymer and, optionally, an ethylenically unsaturated reactive monomer;
wherein the one or more first polymers comprises polyolefin, polyolefin copolymer and/or polyester; and the reactive low molecular weight polymer comprises siloxane polymer, siloxane oil, siloxane copolymer or combination thereof.
